(19) United States
(12) Patent Application Publication
(10) Pub. No.: US 2024/0393820 A1
(43) Pub. Date: Nov. 28, 2024

(54) KNOB ASSEMBLY AND ELECTRONIC DEVICE COMPRISING SAME

(71) Applicant: SAMSUNG ELECTRONICS CO., LTD., Suwon-si, Gyeonggi-do (KR)

(72) Inventors: Geunyong PARK, Suwon-si (KR); Cheoleun CHOI, Suwon-si (KR)

(21) Appl. No.: 18/685,138

(22) PCT Filed: Jul. 15, 2022
(86) PCT No.: PCT/KR2022/010327

§ 371 Date: Feb. 20, 2024

(30) Foreign Application Priority Data
Aug. 20, 2021 (KR) 10-2021-0110042
Oct. 27, 2021 (KR) 10-2021-0144160

(51) Int. Cl. G05G 1/12; H01H 3/08

(52) U.S. Cl. CPC G05G 1/12; H01H 3/08

(57) ABSTRACT

A knob assembly includes a holder including a first surface, a second surface that is opposite to the first surface, and an opening penetrating from the first surface to the second surface, a shaft disposed in the opening, and a knob facing the first surface of the holder and connected to the shaft, wherein the holder includes a hook that is adjacent to an edge of the opening, protrudes from the first surface in a direction of the shaft, and supports the shaft by contacting an outer circumferential surface of the shaft. In addition, various embodiments may be possible.

### CROSS-REFERENCE TO RELATED APPLICATIONS

This application is a National Stage of International Application No. PCT/KR2022/010327 designating the United States, filed on Jul. 15, 2022, in the Korean Intellectual Property Receiving Office and claiming priority to Korean Patent Application No. 10-2021-0110042, filed on Aug. 20, 2021, and Korean Patent Application No. 10-2021-0144160, filed on Oct. 27, 2021, in the Korean Intellectual Property Office, the disclosures of which are incorporated by reference herein in their entireties.

### BACKGROUND

### 1. Field

The disclosure relates to a knob assembly and an electronic device including the same.

### 2. Description of Related Art

A knob assembly may be an input device configured to transmit a signal as a user or an external processor manipulates a knob. The knob assembly has been used as a switch of an electronic device. As a representative knob assembly, there is a rotating-type knob assembly including a rotatable or pushable knob or a push-type knob assembly. In the rotating-type knob assembly, a knob may rotate in a predetermined angle range based on a shaft and may receive an input based on rotation information, for example, a rotation direction, a rotation angle, and rotation velocity. In the push-type knob assembly, a knob and a shaft may be pressed and may receive an input.

Various types of knob assemblies have been developed depending on a structure, shape, and input method of a knob. A knob assembly may input various pieces of information with a single knob and may be applied to various electronic devices due to its excellent intuition and easy manipulation in an input process. For example, a knob assembly may be applied to industrial instrument equipment or home appliance electronic devices, more particularly, a cooking device, such as an oven or a microwave oven, or a clothes processing device, such as a washing machine or a clothes dryer, among the home appliance electronic devices.

### SUMMARY

In a knob assembly and an electronic device including the same, a gap may occur between a shaft and a holder to rotatably or movably fix a knob and the shaft. Due to the gap, when manipulating the knob, the knob may shake, an input may be unclearly transmitted, and the user's feeling of operation may be deteriorated.

Alternatively, in a knob assembly and an electronic device including the same, a contact area may exist between a shaft and a holder to fix the shaft. However, a frictional force may be generated in the contact area and rotation or movement of the knob may be interfered.

The technical goals to be achieved through example embodiments of the present disclosure are not limited to those described above, and other technical goals not mentioned above are clearly understood by one of ordinary skill in the art from the following description.

According to one embodiment, a knob assembly includes a holder including a first surface, a second surface that is opposite to the first surface, and an opening penetrating from the first surface to the second surface, a shaft disposed in the opening, and a knob facing the first surface of the holder and connected to the shaft, wherein the holder includes a hook that is adjacent to an edge of the opening, protrudes from the first surface in a direction of the shaft, and supports the shaft by contacting an outer circumferential surface of the shaft.

According to one embodiment, an electronic device includes a main body may include a drive device, a knob assembly provided on a front surface of the main body, and a processor configured to receive an input signal from the knob assembly and control the drive device, wherein the knob assembly includes a holder including a first surface disposed on the front surface of the main body, a second surface that is opposite to the first surface, and an opening penetrating from the first surface to the second surface, a shaft disposed in the opening, and a knob facing the first surface of the holder and connected to the shaft, wherein the holder includes a plurality of hooks that is adjacent to an edge of the opening, protrudes from the first surface in a direction of the shaft, and is configured to support the shaft by contacting an outer circumferential surface of the shaft, wherein the plurality of hooks is spaced apart from each other to enclose an edge of the shaft.

According to one embodiment, a knob assembly and an electronic device including the same may include a hook supporting a shaft, thereby a frictional force generated during rotation or movement of a knob may be minimized, the shaft may be stably supported, manipulation of the knob may be smoothened, and the user's feeling of operation may be improved.

According to one embodiment, a knob assembly and an electronic device including the same may restrict a range in which a knob tilts due to a gap between the knob and a holder through a structural design of the knob, thereby shaking of the knob may be minimized and feeling of operation may be improved.

### BRIEF DESCRIPTION OF THE DRAWINGS

FIG. 1 is a perspective view of a knob assembly according to one embodiment;

FIG. 2 is a perspective view of an electronic device according to one embodiment;

FIG. 3 is an exploded perspective view of a knob assembly according to one embodiment;

FIG. 4 is a cross-sectional view of a knob assembly according to one embodiment;

FIG. 5 is a front view of a knob assembly according to one embodiment;

FIG. 6 is a perspective view of a knob according to one embodiment;

FIG. 7A is a perspective view of a knob according to one embodiment; and

FIG. 7B is a cross-sectional view of a knob assembly according to one embodiment.

### DETAILED DESCRIPTION

Hereinafter, the embodiments will be described in detail with reference to the accompanying drawings. When describing the embodiments with reference to the accompanying drawings, like reference numerals refer to like components and a repeated description related thereto will be omitted.

It should be appreciated that embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “at least one of A, B, or C”, each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via a third element.

As used in connection with embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one embodiment, the module may be implemented in a form of an application-specific integrated circuit (ASIC).

Embodiments of the present disclosure as set forth herein may be implemented as software (e.g., the program 120) including one or more instructions that are stored in a storage medium (e.g., an internal memory 136 or an external memory 138) that is readable by a machine (e.g., an electronic device). For example, a processor of the machine (e.g., an electronic device) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method according to one embodiment of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least portion of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to one embodiment, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

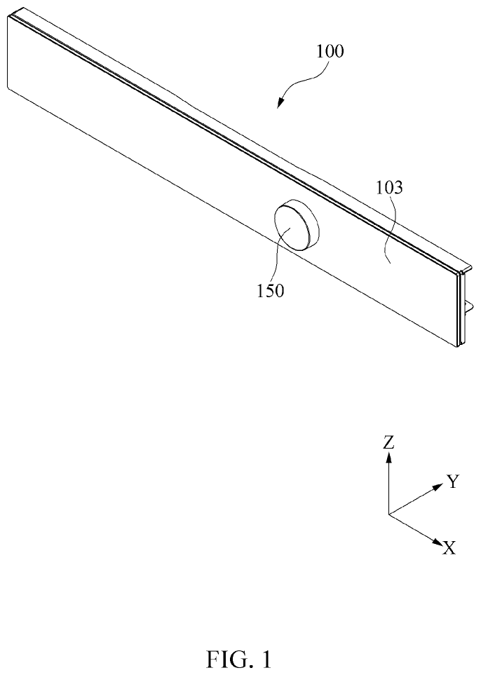

FIG. 1 is a perspective view of a knob assembly 100 according to one embodiment.

Referring to FIG. 1, the knob assembly 100 in one embodiment may include a cover 103 and a knob 150.

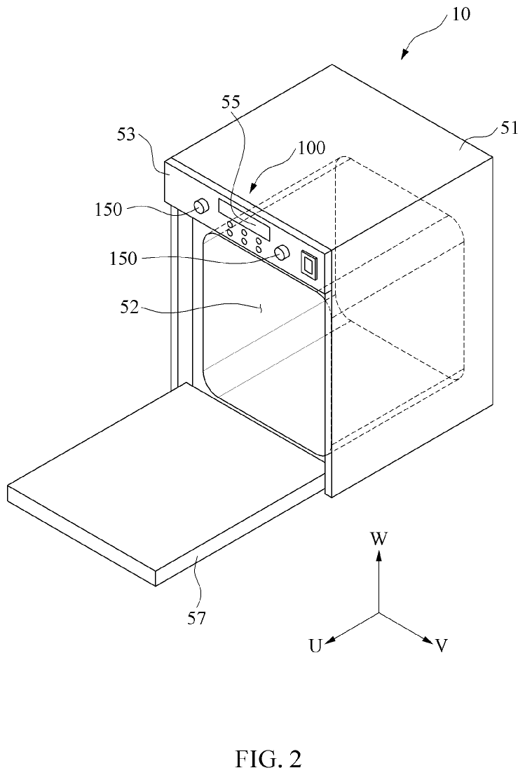

In one embodiment, the knob assembly 100 may be an input device receiving an input from a user or an external system (not shown) and may transmit the received input to a processor (not shown). The knob assembly 100 may be a part of an upper device, for example, an industrial electronic device or a home appliance electronic device (e.g., an electronic device 10 of FIG. 2).

In one embodiment, the knob assembly 100 may include the cover 103 forming an exterior and protecting an internal component and the knob 150 receiving an input. In one embodiment, the knob assembly 100 may receive an input in various methods depending on a type and a structure of the knob 150.

For example, the knob assembly 100 may be a push-type knob assembly 100 in which the knob 150 is pressed in one direction (e.g., a +Y direction or a −Y direction) and receives an input, or may be a rotating-type knob assembly 100 in which the knob 150 is rotatable around a rotation axis and receives an input based on information on rotation of the knob 150 (e.g., a rotation direction, a rotation angle, or angular velocity). Without being limited thereto, the knob assembly 100 may be a complex knob assembly 100 that receives an input in various methods depending on a state change of the knob 150 or includes two or more input methods.

FIG. 2 is a perspective of an electronic device 10 according to one embodiment.

Referring to FIG. 2, the electronic device 10 in one embodiment may include a main body 51 and a control pad 53. To describe the electronic device 10 of FIG. 2, an example of the electronic device 10 including a housing including the main body 51 and a door 57 is illustrated. However, the example is not limited thereto in actual implementation, and the knob assembly 100 may be included in various types of home or industrial equipment. For example, the electronic device 10 including the knob assembly 100 in one embodiment of the present disclosure may be a cooking device, such as an oven or a microwave oven, or may be a clothes processing device, such as a washing machine or a clothes dryer.

In one embodiment, the electronic device 10 may form an internal space 52 in the main body 51. The internal space 52 may be a space in which various tasks are performed, such as a cooking space or a washing space, depending on the type of the electronic device 10. Although not shown in the drawings, the main body 51 may include a drive device (not shown) and a processor (not shown), the drive device (not shown) may drive the electronic device 10, and the processor (not shown) may receive an input signal from the knob assembly 100 and may control the drive device (not shown).

The main body 51 may be a cabinet or a frame of the electronic device 10, may accommodate and protect other components of the electronic device 10, and may form an exterior of the electronic device 10. The main body 51 may include a door 57 coupled at the front and the door 57 may open or close the internal space 52.

In one embodiment, the electronic device 10 may include the control pad 53 provided in a front direction (e.g., a +U direction) of the main body 51 and controlling an operation of the electronic device 10. The control pad 53 may include a display 55 and the knob assembly 100. In one embodiment, the display 55 may be a display device for displaying a drive state and a control state of the electronic device 10 to a user, and the knob assembly 100 may be an input device for a user to control the driving of the electronic device 10.

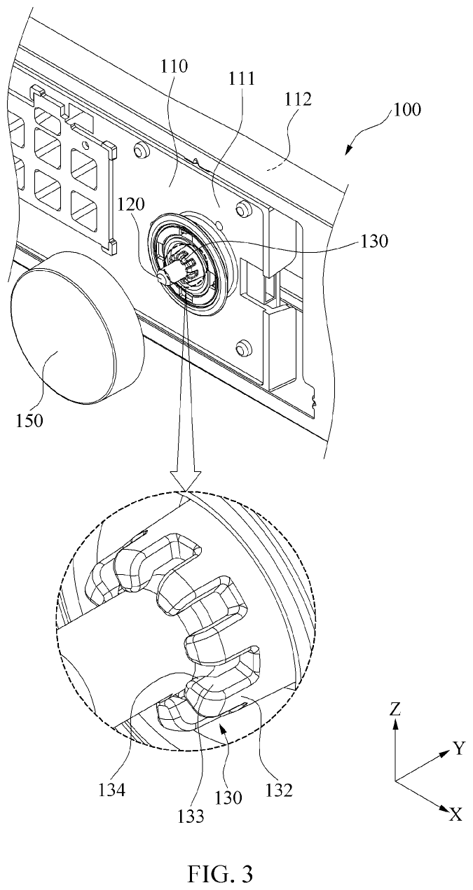

FIG. 3 is an exploded perspective view of the knob assembly 100 according to one embodiment.

Referring to FIG. 3, the knob assembly 100 in one embodiment may include a holder 110, a shaft 120, and a hook 130.

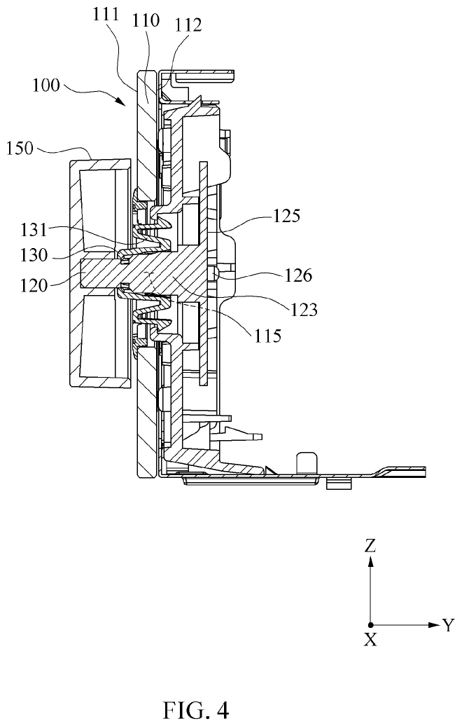

In one embodiment, the holder 110 may support the knob 150 and the shaft 120. The holder 110 may include a first surface 111, a second surface 112 opposite to the first surface 111, and an opening (e.g., an opening 115 of FIG. 4) penetrating from the first surface 111 to the second surface 112.

In one embodiment, the holder 110 may be a plate or a housing disposed inside a cover (e.g., the cover 103 of FIG. 1). For example, the knob assembly 100 may be a housing in which the knob 150 is disposed on the surface 111 in a direction of the second surface 112 to protect an internal component of the knob assembly 100 and form an exterior. In one embodiment, the first surface 111 of the holder 110 may be a surface disposed at a front of a main body of the electronic device 10 of FIG. 2.

In one embodiment, the shaft 120 may be disposed in the opening 115 and may be rotated or moved by the knob 150 as the knob 150 is coupled thereto. In one embodiment, the shaft 120 of the rotating-type knob assembly 100 may rotate in a preset angle range based on a central axis (e.g., the Y-axis), which is a rotation axis of the shaft 120. Alternatively, the shaft 120 of the push-type knob assembly 100 may move in a preset moving range in a direction of the central axis (e.g., the +Y direction or −Y direction) of the shaft 120.

In one embodiment, the knob 150 may be connected to the shaft 120 while the knob 150 faces the first surface 111 of the holder 110. The holder 110 of the knob assembly 100 may include the hook 130 supporting the shaft 120 to enable rotation or movement. In one embodiment, the hook 130 may be integrally provided with the holder 110 by mold injection or may be formed as a hook unit 131 including the hook 130 is inserted into the opening 115 of the holder 110 as shown in FIG. 4.

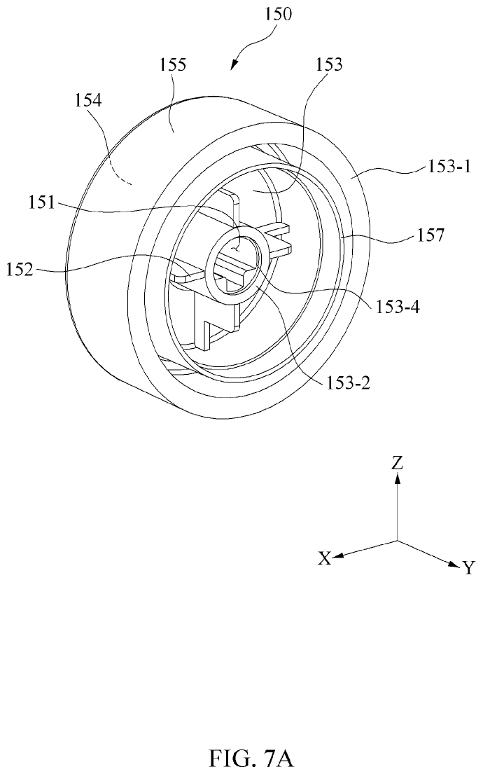

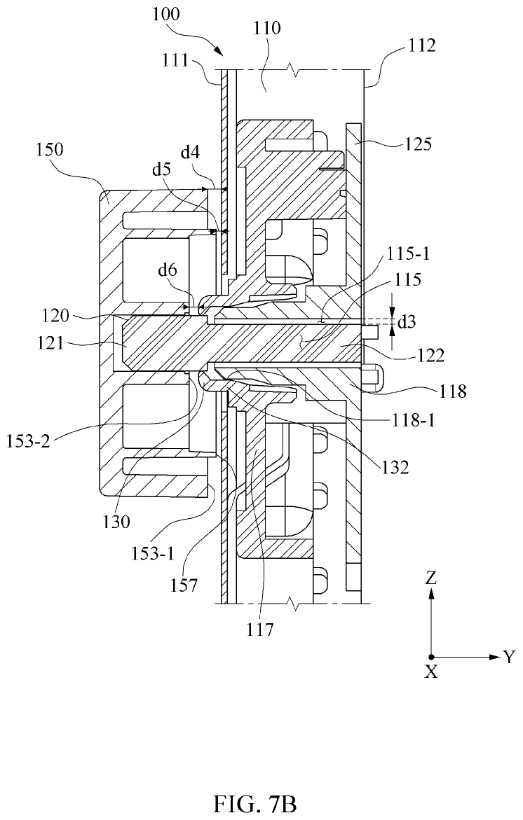

In one embodiment, the hook 130 may support the shaft 120 to prevent the shaft 120 from shaking or escaping from the opening 115. For example, the shaft 120 may rotate or move in the opening 115 to transmit a motion of the knob 150 and a gap (e.g., a gap 115-1 of FIG. 7B) may be provided between the shaft 120 and the opening 115. In the knob assembly 100, as the shaft 120 shakes due to the gap 115-1, the knob 150 or the shaft 120 may shake, the shaft 120 may escape from the holder 110 or may be damaged, a user's feeling of operation of the knob 150 may be deteriorated.

The knob assembly 100 in one embodiment of the present disclosure may include the hook 130 that restricts the movement of the shaft 120 supporting the knob 150. The hook 130 may prevent the knob 150 of the shaft 120 from shaking, may support the knob 150, and may smoothen and improve the feeling of operation of the knob 150 by providing a frictional force in a preset numerical range.

In one embodiment, the hook 130 may be adjacent to an edge of the opening 115 and may protrude from the first surface 111 in a direction of the shaft 120 (e.g., the −Y direction), and may support the shaft 120 by being in contact with an outer circumferential surface of the shaft 120. In one embodiment, the hook 130 may have a straight structure of which at least a portion is bent, or a curved structure, and may extend in a direction (e.g., a direction on an X-Z plane) to protrude from the holder 110 and enclose the shaft 120.

For example, the hook 130 may include a protruding area 132 extending and protruding from the first surface 111 of the holder 110, a curved area 133 bent from the protruding area 132 in a direction of the shaft 120 (e.g., the +Z direction or a direction on the X-Z plane), and a support area 134 extending from the curved area 133 to contact the shaft 120. In the support area 134, an area contacting the shaft may be an end of the hook 130.

In one embodiment, as the support area 134 of the hook 130 extends from the curved area 133, a cross-sectional area of the support area 134 may gradually decrease. The protruding area 132 and the curved area 133 of the hook 130 may require a cross-sectional area that is greater than or equal to a predetermined size to provide bearing power to the hook 130. The support area 134 of the hook 130 may need to support the shaft 120 in a range that does not excessively restrict a motion, such as movement or rotation, of the shaft 120. In one embodiment, the support area 134 may decrease a contact area in contact with the shaft 120 by minimizing a cross-sectional area in contact with the shaft 120 and may decrease a frictional force between the shaft 120 and the hook 130. The hook 130 with decreased frictional force may minimize interference with a motion of the shaft 120 and a user may smoothly and gently manipulate the knob 150.

FIG. 4 is a cross-sectional view of the knob assembly 100 according to one embodiment.

Referring to FIG. 4, the knob assembly 100 in one embodiment may further include the opening 115, the hook unit 131, and a switch 125.

In one embodiment, the opening 115 may be an open area penetrating the first surface 111 facing a front direction (e.g., the −Y direction) of the holder 110 and the second surface 112 facing a rear direction (e.g., the +Y direction) of the holder 110. The first surface 111 of the holder 110 may be a surface exposed to a user or an outside, and the second surface 112 of the holder 110 may be a surface in which an internal component is disposed. The shaft 120 may be disposed in the opening 115, the knob 150 may be coupled to the shaft 120 while facing the first surface 111, and the knob assembly 100 may receive an input from the outside and transmit the input to the inside.

In one embodiment, the hook unit 131 may be a structure that supports or secures the shaft 120 as the hook unit 131 is disposed inside the opening 115. In one embodiment, the hook unit 131 may include a hook 130 contacting an outer circumferential surface of the shaft 120 and may support the switch 125 connected to the shaft 120.

In one embodiment, the switch 125 may be connected to the shaft 120 and may receive an input transmitted to the knob 150. The switch 125 may include a connecting area 123 disposed in the opening 115 and connected to the shaft 120. In the connecting area 123, a partial area (e.g., a second shaft 122 of FIG. 7B) of the shaft may be disposed and a gap (e.g., a gap 115-1 of FIG. 7B) may be formed. The switch 125 may transmit an input signal transmitted through a terminal 126 to another system (e.g., a processor (not shown)).

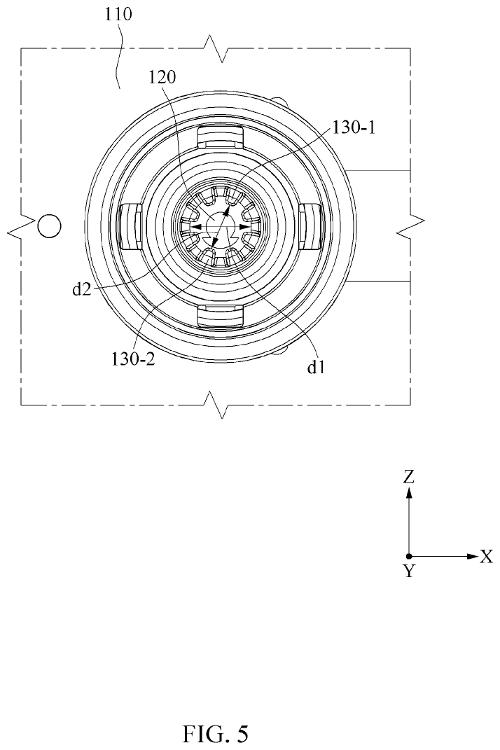

FIG. 5 is a front view of the knob assembly 100 according to one embodiment.

Referring to FIG. 5, the knob assembly 100 in one embodiment may include a plurality of hooks 130.

In one embodiment, the holder 110 may include a plurality of hooks 130, and the plurality of hooks 130 may be spaced apart from each other and enclose an edge of an opening (e.g., the opening 115 of FIG. 4) of the holder 110. In one embodiment, a support area (e.g., the support area 134 of FIG. 3) of each of the plurality of hooks 130 may extend in a direction to enclose the shaft 120. In one embodiment, the plurality of hooks 130 may include two hooks 130, which are a first hook 130-1 and a second hook 130-2, disposed in opposite directions to each other relative to the shaft 120.

In one embodiment, a first width d1 may be a diameter of the shaft 120 in a direction (e.g., a horizontal direction of the X-Z plane) perpendicular to an axis direction (e.g., the Y-axis direction) of the shaft 120 and a second width d2 may be a gap between the first hook 130-1 and an end of the second hook 130-2 or between two ends of the support areas 134.

In one embodiment, the second width d2 may be greater than the first width d1. Specifically, a gap between the plurality of hooks 130 may be greater than a diameter of the shaft 120. For example, the first width d1 may be 6.0 mm and the second width d2 may be 6.1 mm. The plurality of hooks 130 may be formed of a rigid material and may stably support the shaft 120.

In one embodiment, at least some of the plurality of hooks 130 may temporarily contact the shaft 120, and the plurality of hooks 130 may minimize interference with rotation or movement of the shaft 120 and may restrict a moving range of the shaft 120. When all or some of the plurality of hooks 130 are always in contact with the shaft 120, a frictional force may be applied to a gap between the shaft 120 and the plurality of hooks 130, and manipulation of the knob 150 may be inconvenient because rotation or movement of the shaft 120 is restricted. As the second width d2, which is a gap between the plurality of hooks 130, is slightly greater than the first width d1, which is a diameter of the shaft 120, a frictional force that interferes with movement or rotation of the shaft 120 may be minimized and the knob 150 and the shaft 120 may be prevented from shaking as a moving range of the shaft 120 is restricted. In one embodiment, the plurality of hooks 130 may be spaced apart from the shaft 120 and may be temporarily in contact with the shaft 120 only when the shaft 120 rotates or moves.

In one embodiment, the second width d2 may be less than or equal to the first width d1. Specifically, the gap between the plurality of hooks 130 may be the same as the diameter of the shaft 120, or when the shaft 120 is separated from the holder 110, the gap between the plurality of hooks 130 may be less than the diameter of the shaft 120. For example, the first width d1 may be 6.0 mm, the second width d2 may be 6.0 mm, or when the shaft 120 is separated from the holder 110, the second width d2 may be 5.7 mm.

In one embodiment, the plurality of hooks 130 may always be in contact with the shaft 120 while pressing the shaft 120 and may restrict a moving range of the shaft 120 while minimizing interference with the rotation or movement of the shaft 120. The plurality of hooks 130 may be formed of an elastic body, the shaft 120 may be disposed between the plurality of hooks 130 and may press the plurality of hooks 130 in an outward direction of the shaft 120, and the plurality of hooks 130 may press the shaft 120 in a central direction of the shaft 120.

In the push-type knob assembly 100 in one embodiment, when a user presses the knob 150, the plurality of hooks 130 may guide the shaft 120 to move in a pressing direction (e.g., the + and/or −Y direction) and may support the shaft 120 to prevent the shaft 120 from shaking in a different direction.

In the rotation knob assembly 100 in one embodiment, when the user rotates the knob 150 in a preset angle range, the plurality of hooks 130 may guide the shaft 120 to rotate in the preset angle range, may provide an elastic force to cause the shaft 120 to return to a previous state when external pressure by the user is removed and may support the knob 150 to prevent the knob 150 from shaking in a different direction.

By variously setting a gap between the plurality of hooks 130 and a material of the plurality of hooks 130, the plurality of hooks 130 in one embodiment may prevent the knob 150 from shaking by restricting a moving range of the shaft 120 to correspond to a manipulation method and a manipulation environment of the knob assembly 100 and may improve the user's feeling of operation.

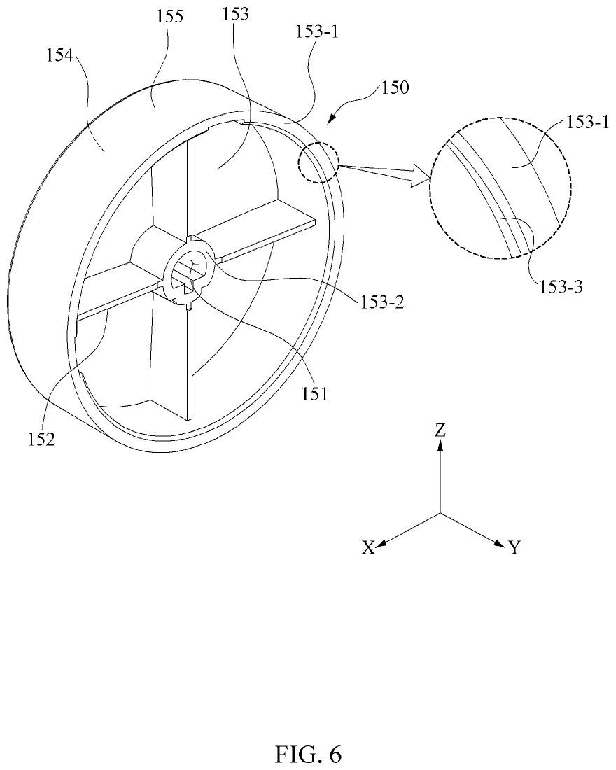

FIG. 6 is a perspective view of the knob 150 according to one embodiment.

Referring to FIG. 6, the knob 150 in one embodiment may include a third surface 153, a fourth surface 154, and a coupling groove 151.

In one embodiment, the knob 150 may include the third surface 153 in a direction (e.g., the +Y direction) facing a first surface (e.g., the first surface 111 of FIG. 3) of a holder (e.g., the holder 110 of FIG. 3), the fourth surface 154 in a direction (e.g., the −Y direction) that is opposite to the third surface 153, and the fifth surface 155 that is a side surface from the third surface 153 to the fourth surface 154.

In one embodiment, the fourth surface 154 of the knob 150 may be a surface exposed to the outside of the knob assembly 100, and the third surface 153 of the knob 150 may be a surface to which the shaft 120 is connected. In one embodiment, the fourth surface 154 and the fifth surface 155 of the knob 150 may be substantially flat or may have a curved structure such that a user may easily grip, and may be, for example, a cylindrical shape or a spherical shape as shown in FIG. 6.

In one embodiment, the coupling groove 151 may be provided on the third surface 153 of the knob 150 and may be a groove into which a shaft (e.g., the shaft 120 of FIG. 3) is inserted. The third surface 153 may include a central area 153-2 that is adjacent to the coupling groove 151 and encloses the coupling groove 151, and an outer area 153-1 that is adjacent to the fifth surface 155 and spaced apart from the central area 153-2.

In one embodiment, ribs 152 and 157 may be provided between the central area 153-2 and the outer area 153-1 of the knob 150 and may protrude from the third surface 153 in a direction (e.g., the +Y direction) of the holder 110. In one embodiment, the ribs 152 and 157 may include a first rib 152 extending from the central area 153-2 in a direction of the outer area 153-1 and/or a second rib (e.g., the second rib 157 of FIG. 7A) provided between the central area 153-2 and the outer area 153-1.

In one embodiment, the outer area 153-1 may include a first step area 153-3 extending in a direction of the central area 153-2 and receding from the first surface 111 of the holder 110. The first step area 153-3 may be a partial area of the outer area 153-1 inserted in a direction of the third surface 153. The first step area 153-3 may minimize a contact area between the first surface 111 of the holder 110 and the third surface 153 of the knob 150, may decrease a frictional force occurring between the holder 110 and the knob 150, may smoothen manipulation of the knob 150, and may improve the feeling of operation of the knob assembly 100.

FIG. 7A is a perspective view of the knob 150 according to one embodiment and FIG. 7B is a cross-sectional view of the knob assembly 100 according to one embodiment.

Referring to FIG. 7A, the knob 150 in one embodiment may include the second rib 157 and a second step area 153-4, and referring to FIG. 7B, the shaft 120 may include a first shaft 121, a second shaft 122, and a gap 115-1.

To describe FIGS. 7A and 7B, a description that is the same as or similar to the description of the knob assembly 100 provided above is omitted and the descriptions provided above and below may be replaced, combined, or transformed in a scope in which one of ordinary skill in the art may easily derive.

In one embodiment, the second rib 157 may protrude more than the outer area 153-1 from the third surface 153 in a direction (e.g., the +Y direction) of the first surface 111 of the holder 110. In one embodiment, the first rib 152 may have a vertical structure radiating from the central area 153-2 to the outer area 153-1, and the second rib 157 may have a concentric structure disposed between the central area 153-2 and the outer area 153-1.

In one embodiment, the knob 150 and the holder 110 may be spaced apart from each other at a preset interval. For example, based on a state of FIG. 7B in which the knob 150 is connected to the shaft 120, a gap between the outer area 153-1 of the knob 150 and the holder 110 may be defined as a fourth width d4, a gap between the second rib 157 of the knob 150 and the holder 110 may be defined as a fifth width d5, and a gap between the central area 153-2 of the knob 150 and the holder 110 may be defined as a sixth width d6. In the push-type knob assembly 100 in one embodiment, the third width d3 to the sixth width d6 may be greater than a sensing gap in which the knob 150 is sensed as an input by being pushed and moved.

In one embodiment, the second rib 157 may protrude more than the outer area 153-1 from the third surface 153 in a direction of the holder 110. That is, the fifth width d5 may be less than the fourth width d4. For example, the fourth width d4 may be 1.5 mm, the fifth width d5 may be 0.6 mm, the sixth width d6 may be 0.8 mm, and the sensing gap in which the knob 150 is pushed and moved may be designed to be 0.4 mm to 0.5 mm.

In one embodiment, the knob assembly 100 may move in a direction (e.g., the +Y direction) by a preset distance as the knob 150 is pressed or a partial area of the knob 150 may tilt close to the holder 110 based on a horizontal direction (e.g., the X-Z plane direction). For example, the knob 150 may tilt as an upper part of the knob 150 approaches in a direction (e.g., the +Y direction) of the holder 110 and a lower part of the knob 150 moves away in an opposite direction (e.g., the −Y direction). The second rib 157 may protrude more than the outer area 153-1 and may contact the holder 110 before the outer area 153-1 contacts the holder 110, thereby may restrict a tilt angle of the knob 150.

When the knob assembly 100 in one embodiment does not include the second rib 157, a partial area of the knob 150 may tilt up to a range in which the outer area 153-1 contacts the holder 110, for example, may tilt up to a 5-degree range relative to a surface (e.g., the X-Z plane) that is horizontal to the holder 110. When the knob assembly 100 in one embodiment includes the second rib 157, a partial area of the knob 150 may tilt up to a range in which the second rib 157 contacts the holder 110, for example, may tilt up to a 2.5-degree range relative to a surface that is horizontal to the holder 110.

In one embodiment, the second rib 157 may restrict a tilt angle of the knob 150 by contacting the holder 110 before the outer area 153-1 is in contact, and the knob 150 may be prevented from shaking and the feeling of operation of the knob assembly 100 may be improved by restricting a range in which a partial area shakes or tilts when pressing or rotating the knob 150.

In one embodiment, the second rib 157 may have a continuous structure enclosing the coupling groove 151, for example, may have a concentric structure with the coupling groove 151 and/or the outer area 153-1. The continuous second rib 157 may restrict an angle in which the knob 150 substantially and uniformly tilts in all directions. Without being limited thereto, the second rib 157 in one embodiment may have a discontinuous structure in which a plurality of pillars is arranged.

In one embodiment, the central area 153-2 may include a second step area 153-4 extending in a direction of the shaft 120 and receding from the first surface 111 of the holder 110. The second step area 153-4 may be a partial area of the central area 153-2 inserted in a direction of the third surface 153. The second step area 153-4 may form a multistep structure to couple the shaft 120 to the knob 150.

In one embodiment, the second step area 153-4 may increase a contact area of the knob 150 with the shaft 120, and the knob 150 and the shaft 120 may contact in various directions and may mutually improve a fixation force. The second step area 153-4 may minimize shaking of the knob 150 and may improve the feeling of operation of the knob assembly 100.

In one embodiment, the shaft 120 may include a first shaft 121 and a second shaft 122, and the holder 110 may include a main holder 117 and an auxiliary holder 118. The first shaft 121 may be coupled to the knob 150 and may support the knob 150, and the second shaft 122 may be disposed in the opening 115 of the holder 110 and may be connected to the first shaft 121. The main holder 117 may support the auxiliary holder 118 and may be provided with the hook 130, and the auxiliary holder 118 may be provided with the opening 115, and may fix the shaft 120 while enclosing the second shaft 122 such that the second shaft 122 may be able to move.

In one embodiment, the auxiliary holder 118 may include a contact surface 118-1 in which the auxiliary holder 118 contacts the main holder 117. In one embodiment, the contact surface 118-1 may contact a partial area of the main holder 117, for example, may be adjacent to the protruding area 132 of the hook 130 and may contact the main holder 117. The main holder 117 may fix the auxiliary holder 118 to prevent the auxiliary holder 118 from escaping and may form a gap 115-1 between the auxiliary holder 118 and the second shaft 122. For example, the gap 115-1 having the third width d3 may be formed between the auxiliary holder 118 and the second shaft 122. The gap 115-1 may be a space formed to easily and smoothly move the shaft 120 and may be formed during a coupling process of the holder 110 to the shaft 120.

In one embodiment, in the knob assembly 100, the shaft 120 may be spaced apart from the auxiliary holder 118 by the gap 115-1, friction between the shaft 120 and the auxiliary holder 118 may be minimized, and the shaft 120 may smoothly move or rotate. In one embodiment, in the knob assembly 100, the shaft 120 may be shaken by the gap 115-1, the hook 130 may support the first shaft 121, may restrict a moving range of the first shaft 121, and may minimize shaking of the knob 150.

The knob assembly 100 in one embodiment may include the holder 110 including the first surface 111, the second surface 112 that is opposite to the first surface 111, and the opening 115 penetrating from the first surface 111 to the second surface 112, the shaft 120 disposed in the opening 115, and the knob 150 facing the first surface 111 of the holder 110 and connected to the shaft 120, wherein the holder 110 may include the hook 130 that is adjacent to an edge of the opening 115, protrudes from the first surface 111 in a direction of the shaft 120, and supports the shaft 120 by contacting an outer circumferential surface of the shaft 120.

In one embodiment, the hook 130 may include the protruding area 132 extending and protruding from the first surface 111 of the holder 110, the curved area 133 bent from the protruding area 132 in the direction of the shaft 120, and the support area 134 extending from the curved area 133 to be in contact with the shaft 120.

In one embodiment, a cross-sectional area of the support area 134 gradually may decrease as the support area 134 extends from the curved area 133.

In one embodiment, the holder 110 may include a plurality of hooks 130, and the plurality of hooks 130 is spaced apart from each other to enclose the edge of the opening 115.

In one embodiment, the first width d1 that is a diameter of the shaft 120, and the second width d2 that is a gap between ends of two hooks 130-1 and 130-2 of the plurality of hooks disposed in opposite directions to each other relative to the shaft 120 may be included, wherein the second width d2 may be greater than the first width d1.

In one embodiment, the first width d1 that is a diameter of the shaft 120, and the second width d2 that is a gap between two hooks 130-1 and 130-2 of the plurality of hooks disposed in opposite directions to each other relative to the shaft 120, wherein the second width d2 may be less than or equal to the first width d1 and the plurality of hooks 130 may include an elastic body.

In one embodiment, the shaft 120 may include the first shaft 121 coupled to the knob 150 and supporting the knob 150, and the second shaft 122 disposed inside the opening 115 and connected to the first shaft 121, wherein the hook 130 may support the first shaft 121.

In one embodiment, the holder 110 may include the auxiliary holder 118 provided with the opening 115, enclosing the second shaft 122, and supporting the shaft 120 to enable the shaft 120 to move, and the main holder 117 supporting the auxiliary holder 118 and provided with the hook 130.

In one embodiment, the knob 150 may include the third surface 153 facing the first surface 111 of the holder 110, the fourth surface 154 that is opposite to the third surface 153, and the coupling groove 151 into which the shaft 120 is inserted, wherein the coupling groove 151 may be provided on the third surface 153, and the third surface 153 may include the central area 153-2 that is adjacent to the coupling groove 151 and the outer area 153-1 spaced apart from the central area 153-2.

In one embodiment, the knob 150 may include the rib 157 provided between the central area 153-2 and the outer area 153-1, and the rib 157 may protrude more than the outer area 153-1 from the third surface 153 in a direction of the holder 110.

In one embodiment, the rib 157 may include a continuous structure while enclosing the coupling groove 151.

In one embodiment, the outer area 153-1 may include the first step area 153-3 extending in a direction of the central area 153-2 and receding from the first surface 111.

In one embodiment, the central area 153-2 may include the second step area 153-4 extending in the direction of the shaft 120 and receding from the first surface 111.

The electronic device 10 in one embodiment may include the main body 51 including a drive device (not shown), the knob assembly 100 provided on a front surface of the main body 51, and a processor (not shown) configured to receive an input signal from the knob assembly 100 and control the drive device (not shown), wherein the knob assembly 100 may include the holder 110 including the first surface 111 disposed on the front surface of the main body 51, the second surface 112 that is opposite to the first surface 111, and the opening 115 penetrating from the first surface 111 to the second surface 112, the shaft 120 disposed in the opening 115, and the knob 150 facing the first surface 111 of the holder 110 and connected to the shaft 120, wherein the holder 110 may include a plurality of hooks 130 that is adjacent to an edge of the opening 115, protrudes from the first surface 111 in a direction of the shaft 120, and supports the shaft 120 by contacting an outer circumferential surface of the shaft 120, wherein the plurality of hooks 130 may be spaced apart from each other to enclose an edge of the shaft 120.

In one embodiment, the first width d1 that is a diameter of the shaft 120, and the second width d2 that is a gap between ends of two of the plurality of hooks 130 disposed in opposite directions to each other relative to the shaft 120 may be included, wherein the second width may be greater than the first width.

In one embodiment, the first width d1 that is a diameter of the shaft 120, and the second width d2 that is a gap between two of the plurality of hooks 130 disposed in opposite directions to each other relative to the shaft 120 may be included, wherein the second width d2 may be less than the first width d1 and the plurality of hooks 130 may include an elastic body.

In one embodiment, the knob 150 may include the third surface 153 facing the first surface 111 of the holder 110, the fourth surface 154 that is opposite to the third surface 153, and the coupling groove 151 into which the shaft 120 is inserted, wherein the coupling groove 151 may be provided on the third surface 153, and the third surface 153 may include the central area 153-2 that is adjacent to the coupling groove 151 and the outer area 153-1 spaced apart from the central area 153-2.

In one embodiment, the knob 150 may include the rib 157 provided between the central area 153-2 and the outer area 153-1 and protruding from the third surface 153 in a direction of the holder 110.

In one embodiment, the outer area 153-1 may include the first step area 153-3 extending in a direction of the central area 153-2 and receding from the first surface 111.

In one embodiment, the central area 153-2 may include the second step area 153-4 extending in the direction of the shaft 120 and receding from the first surface 111.

Although preferred embodiments are shown and described above, the present disclosure is not limited to a specific embodiment described above. Without being departed from the scope of the claims, various modifications may be made by those skilled in the art in the technical field to which the present disclosure belongs and such modifications shall not be separately understood from the technical idea or perspective.

1. A knob assembly comprising:
a holder comprising:
a first surface,
a second surface that is opposite to the first surface, and
an opening penetrating from the first surface to the second surface;
a shaft disposed in the opening; and
a knob facing the first surface of the holder and connected to the shaft,
wherein the holder comprises:
a hook that is adjacent to an edge of the opening, protrudes from the first surface in a direction of the shaft, and is configured to support the shaft by contacting an outer circumferential surface of the shaft.

2. The knob assembly of claim 1, wherein the hook comprises:
a protruding area extending and protruding from the first surface of the holder;
a curved area bent from the protruding area in the direction of the shaft; and
a support area extending from the curved area to be in contact with the shaft.

3. The knob assembly of claim 2, wherein a cross-sectional area of the support area gradually decreases as the support area extends from the curved area.

4. The knob assembly of claim 1, wherein:
the holder comprises a plurality of hooks, and
the plurality of hooks is spaced apart from each other to enclose the edge of the opening.

5. The knob assembly of claim 4, wherein:
the knob assembly comprises:
a first width that is a diameter of the shaft; and
a second width that is a gap between ends of two of the plurality of hooks disposed in opposite directions to each other relative to the shaft, and
the second width is greater than the first width.

6. The knob assembly of claim 4, wherein:
the knob assembly comprises:
a first width that is a diameter of the shaft; and
a second width that is a gap between two of the plurality of hooks disposed in opposite directions to each other relative to the shaft, and
the second width is less than or equal to the first width and the plurality of hooks comprises an elastic body.

7. The knob assembly of claim 1, wherein:
the shaft comprises:
a first shaft coupled to the knob and supporting the knob, and
a second shaft disposed inside the opening and connected to the first shaft, and the hook supports the first shaft.

8. The knob assembly of claim 7, wherein the holder comprises:
an auxiliary holder provided with the opening, enclosing the second shaft, and configured to support the shaft to enable the shaft to move, and
a main holder supporting configured to support the auxiliary holder and provided with the hook.

9. The knob assembly of claim 1, wherein:
the knob comprises:
a third surface facing the first surface of the holder,
a fourth surface that is opposite to the third surface, and
a coupling groove into which the shaft is inserted, wherein the coupling groove is provided on the third surface, and
the third surface comprises:
a central area that is adjacent to the coupling groove, and
an outer area spaced apart from the central area.

10. The knob assembly of claim 9, wherein:
the knob comprises a rib provided between the central area and the outer area, and
the rib protrudes more than the outer area from the third surface in a direction of the holder.

11. The knob assembly of claim 10, wherein the rib comprises a continuous structure while enclosing the coupling groove.

12. The knob assembly of claim 9, wherein the outer area comprises a first step area extending in a direction of the central area and receding from the first surface.

13. The knob assembly of claim 9, wherein the central area comprises a second step area extending in the direction of the shaft and receding from the first surface.

14. An electronic device comprising:
a main body comprising a drive device;
a knob assembly provided on a front surface of the main body; and
a processor configured to receive an input signal from the knob assembly and control the drive device,
wherein the knob assembly comprises:
a holder comprising a first surface disposed on the front surface of the main body, a second surface that is opposite to the first surface, and an opening penetrating from the first surface to the second surface;
a shaft disposed in the opening; and
a knob facing the first surface of the holder and connected to the shaft,
wherein the holder comprises:
a plurality of hooks that is adjacent to an edge of the opening, protrudes from the first surface in a direction of the shaft, and is configured to support the shaft by contacting an outer circumferential surface of the shaft, and
wherein the plurality of hooks is spaced apart from each other to enclose an edge of the shaft.

15. The electronic device of claim 14, wherein:
the electronic device comprises:
a first width that is a diameter of the shaft; and
a second width that is a gap between ends of two of the plurality of hooks disposed in opposite directions to each other relative to the shaft, and
the second width is greater than the first width.
